(19) United States
(12) Patent Application Publication
(10) Pub. No.: US 2015/0259962 A1
(43) Pub. Date: Sep. 17, 2015

(54) MULTIFUNCTION FRAME FOR AN ELECTRIC SLIDING DOOR

(71) Applicant: DOOR & WINDOW HARDWARE CO., Taichung City (TW)

(72) Inventors: Wei-Hung CHANG, Taichung City (TW); Sung-Hui LIN, Taichung City (TW)

(73) Assignee: DOOR & WINDOW HARDWARE CO., Taichung City (TW)

(21) Appl. No.: 14/204,108

(22) Filed: Mar. 11, 2014

(51) Int. Cl. E05D 15/06

(52) U.S. Cl. CPC E05D 15/0626; E05D 15/06

(57) ABSTRACT

A multifunction frame for an electric sliding door has a body, a holding segment, a connecting segment, a positioning rod and a hub frame. The body has a mounting recess, a rear opening and two side holes. The rear opening and the side holes communicate with the mounting recess. The holding segment is formed on and protrudes from a bottom of the body and has two holding hooks. The connecting segment is formed on and protrudes from a top of the body and has at least one connecting hook. The positioning rod is formed on and protrudes from a front side of the body near the top of the body. The hub frame is formed on and protrudes from the front side of the body below the positioning rod and has a front opening formed through a front side of the hub frame.

### BACKGROUND OF THE INVENTION

1. Field of the Invention

The present invention relates to a multifunction frame, and more particularly relates to a multifunction frame for an electric sliding door that has a simplified structure to reduce the whole volume of the electric sliding door and can connect with multiple components of the electric sliding door.

2. Description of Related Art

A conventional electric sliding door has a box, a driving device and a sliding door device. The box is transversally and securely mounted between two walls and has a hub mounted in the box, multiple pulleys mounted in the box and a belt mounted around the pulleys. The driving device is connected to the box and has a connecting frame and a driving motor. The connecting frame is securely connected to a rear side of the box. The driving motor is mounted in the connecting frame, faces the box and has a front end and a driving wheel. The driving wheel is connected to the front end of the driving motor and is connected to the belt. The sliding door device is connected to the box and the driving device below the box and has two stationary doors and two moving doors. The stationary doors are respectively connected to the walls below the box. The moving doors can be driven to move relative to the stationary doors by the driving device below the box. The moving doors can be moved to or move away from each other by the driving device to provide an effect of closing or opening the conventional electric sliding door.

Although the conventional electric sliding door can provide an effect of closing or opening the moving doors relative to the stationary doors, the conventional electric sliding door needs to mount the connecting frame on the rear side of the box to hold the driving motor and this will increase the whole volume of the conventional electric sliding door. Then, it needs a relatively large space to assemble the conventional electric sliding door between two walls, and the whole weight of the conventional electric sliding door will be increased by the connecting frame. In addition, if other components are needed to connect to the conventional electric sliding door, it still needs other frames to hold the components on the conventional electric sliding door and this will increase the whole volume, the whole weight and the structural complexity of the conventional electric sliding door. Furthermore, the time and cost of maintaining and assembling the conventional electric sliding door will be increased. Therefore, the conventional electric sliding door needs improvement.

To overcome the shortcomings, the present invention provides a multifunction frame for an electric sliding door to mitigate the aforementioned problems.

### SUMMARY OF THE INVENTION

The main objective of the present invention is to provide a multifunction frame for an electric sliding door that has a simplified structure to reduce the whole volume of the electric sliding door and can connect with multiple components of the electric sliding door.

The multifunction frame for an electric sliding door in accordance with the present invention has a body, a holding segment, a connecting segment, a positioning rod and a hub frame. The body has a mounting recess, a rear opening and two side holes. The rear opening and the side holes communicate with the mounting recess. The holding segment is formed on and protrudes from a bottom of the body. The connecting segment is formed on and protrudes from a top of the body and has at least one connecting hook. The positioning rod is formed on and protrudes from a front side of the body near the top of the body. The hub frame is formed on and protrudes from the front side of the body below the positioning rod.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a multifunction frame for an electric sliding door in accordance with the present invention, connected to the electric sliding door;

FIG. 2 is another perspective view of a multifunction frame for an electric sliding door in accordance with the present invention, connected to the electric sliding door;

FIG. 3 is an enlarged perspective view of the multifunction frame in FIG. 1;

FIG. 4 is another enlarged perspective view of the multifunction frame in FIG. 1;

FIG. 5 is a cross sectional side view of the multifunction frame in FIG. 3;

FIG. 6 is an operational front view of the multifunction frame in FIG. 1, connected to the electric sliding door;

FIG. 7 is an operational cross sectional view in partial section of the multifunction frame along line 7-7 in FIG. 6;

FIG. 8 is an operational cross sectional view in partial section of the multifunction frame along line 8-8 in FIG. 6; and

FIG. 9 is an operational cross sectional view in partial section of the multifunction frame along line 9-9 in FIG. 6.

### DETAILED DESCRIPTION OF PREFERRED EMBODIMENT

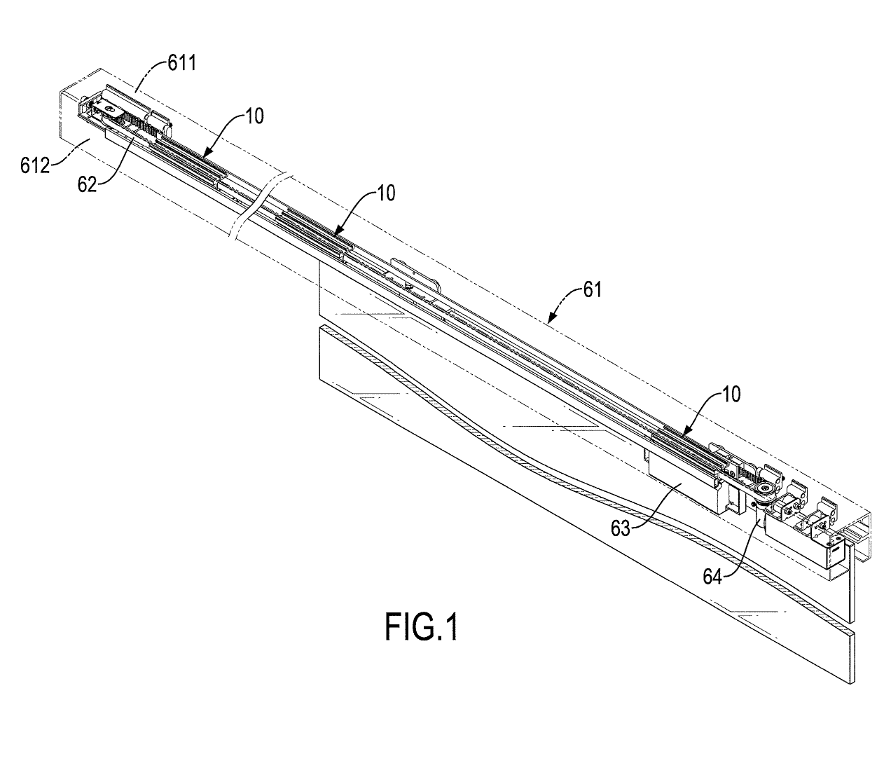

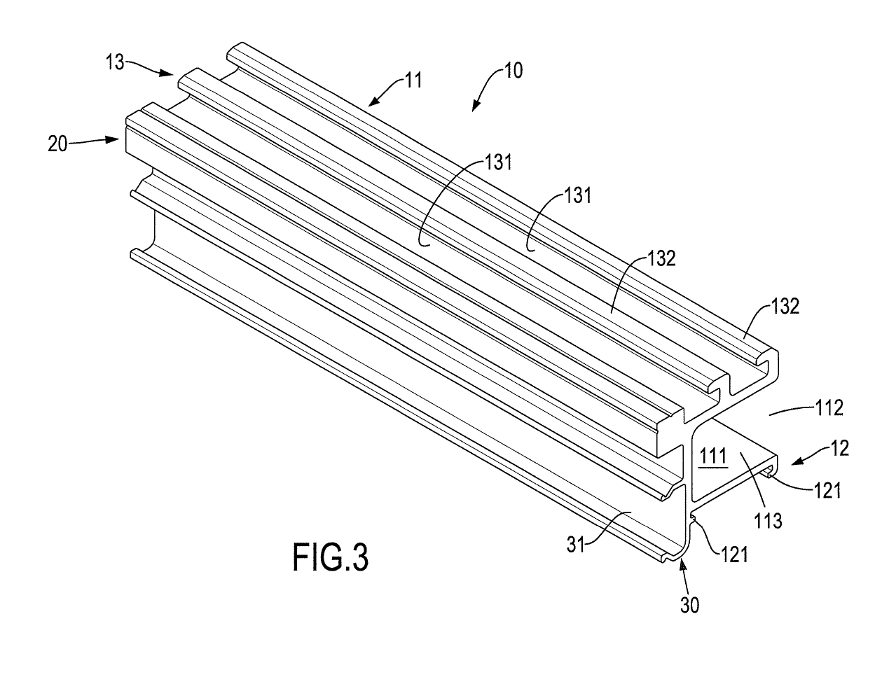

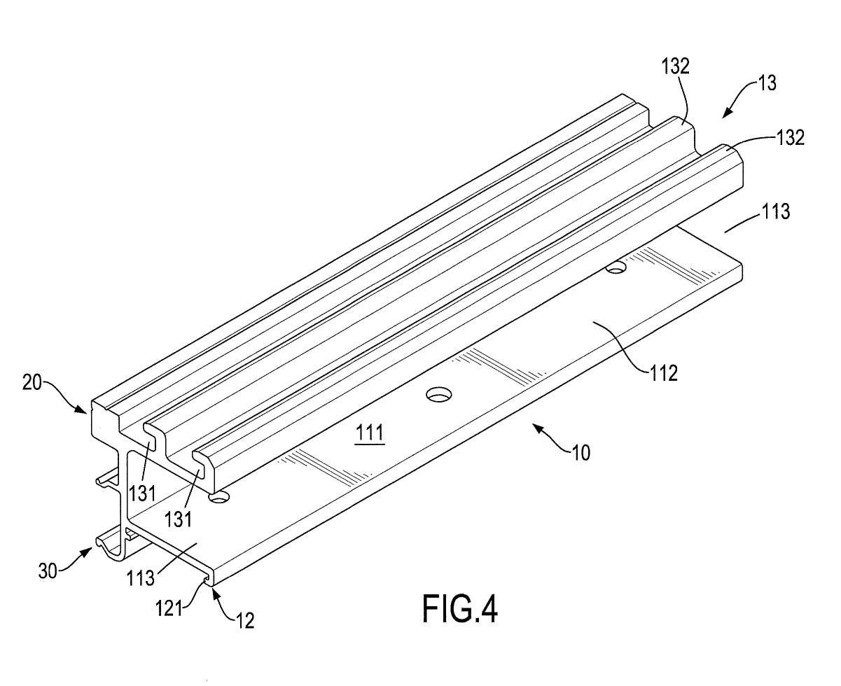

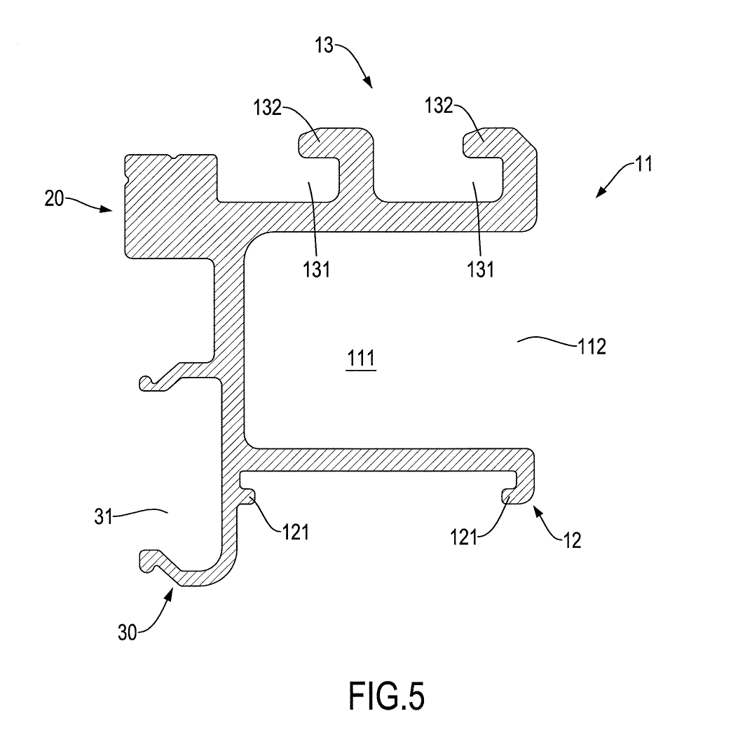

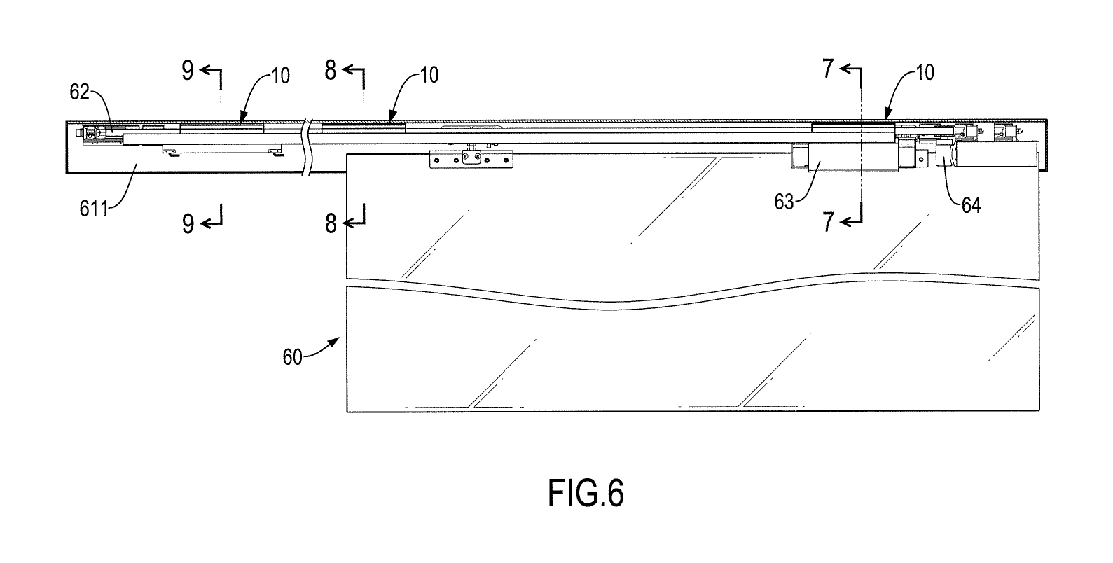

With reference to FIGS. 1 to 4, a multifunction frame 10 for an electric sliding door 60 having a box 61, a belt 62, a control box 63, a driving motor 64 and a hub in accordance with the present invention is mounted in the box 61 of the electric sliding door 60 and comprises a body 11, a holding segment 12 and a connecting segment 13. The box 61 has a casing 611 and a covering board 612 connected to the casing 611. The body 11 may be elongated U-shaped and has a front side, a rear side, two opposite sides, a top, a bottom, a length, a mounting recess 111, a rear opening 112, two side holes 113 and at least one supporting pulley 114. The mounting recess 111 is formed in the body 11. The rear opening 112 is formed through the rear side of the body 11 and communicates with the mounting recess 111. With reference to FIGS. 3 to 5, the side holes 113 are respectively formed through the opposite sides of the body 11 and communicate with the mounting recess 111. Then, the belt 62 is mounted in the mounting recess 111 of the body 11 via the side holes 113. With further reference to FIGS. 6 to 9, the at least one supporting pulley 114 is mounted in the mounting recess 111 of the body 11 and is connected to the belt 62.

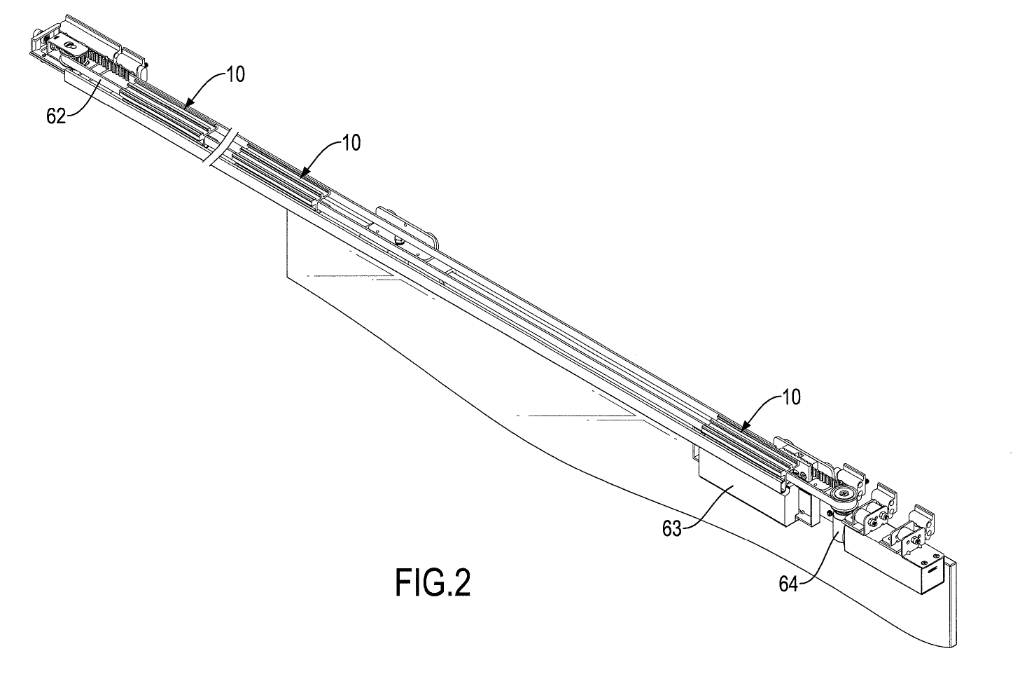

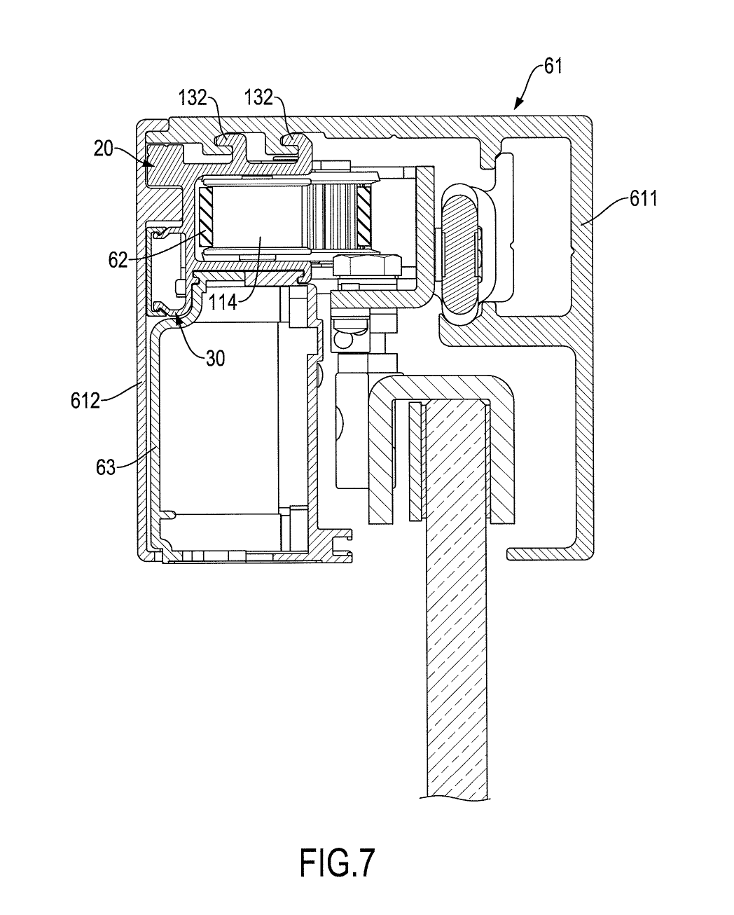

With reference to FIGS. 1 and 2, the holding segment 12 is formed on and protrudes from the bottom of the body 11 to hold the control box 63 in the box 61 and has two holding hooks 121. The holding hooks 121 are formed on and protrude from the lower side of the body 11, face to each other and each one of the holding hooks 121 has a length equal to the length of the body 11. With reference to FIG. 7, the control box 63 can be securely connected to the holding hooks 121 of the holding segment 12 to mount in the box 61, below the mounting recess 111 of the body 11 and between the casing 611 and the covering board 612 without using other frames.

The connecting segment 13 is formed on and protrudes from the top of the body 11, is slidably connected to the box 61 to enable the body 11 to mount in the box 61 and has a top, at least one sliding groove 131 and at least one connecting hook 132. Each one of the at least one sliding groove 131 is formed in the top of the connecting segment 13 and has a length equal to the length of the body 11. The at least one connecting hook 132 is formed on and protrudes from the top of the body 11. Preferably, the connecting segment 13 has two connecting hooks 132 formed on and protruding from the top of the body 11 and connected to the box 61. The at least one sliding groove 131 is formed in the connecting segment 13 by the connecting hooks 132.

Additionally, with reference to FIGS. 3 to 5, the multifunction frame 10 has a positioning rod 20 formed on and protruding from the front side of the body 11 near the top of the body 11 and facing the covering board 612.

Furthermore, the multifunction frame 10 has a hub frame 30 formed on and protruding from the front side of the body 11 below the positioning rod 20 to hold the hub in the box 61 of the electric sliding door 60. The hub frame 30 has a front side and a front opening 31 formed through the front side of the hub frame 30.

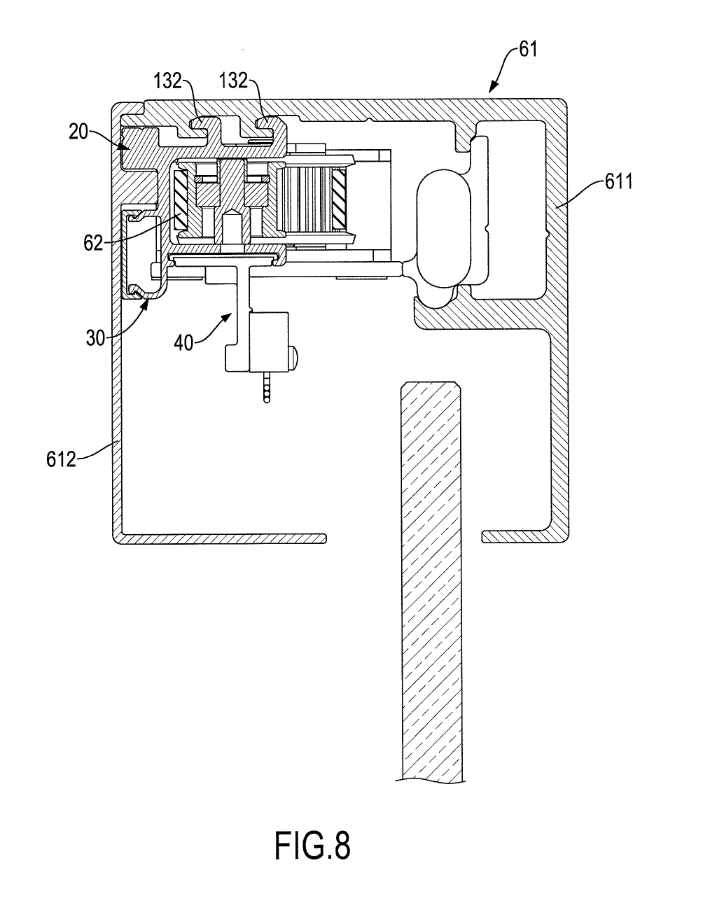

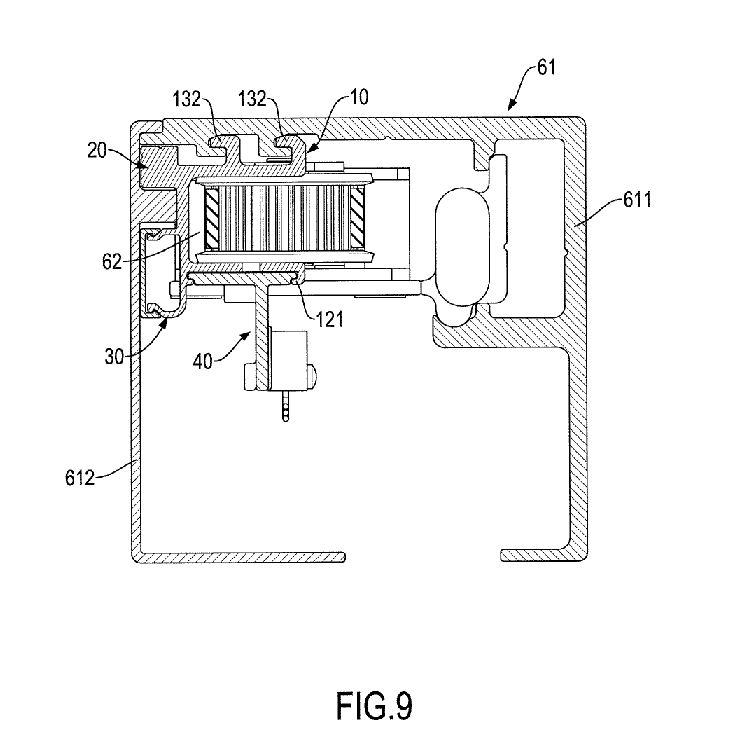

Preferably, with reference to FIGS. 8 and 9, the multifunction frame 10 has a supporting arm 40 being L-shaped, connected to the holding segment 12 between the holding hooks 121 to connect other components of the electric sliding door 60 in the box 61 without using other frames.

According to the above-mentioned features and structural relationships of the multifunction frame 10 in accordance with the present invention, when the multifunction frame 10 is connected to the electric sliding door 60, the user can assemble one or more multifunction frames 10 in the box 61 between the casing 611 and the covering board 612. Then, each one of the multifunction frames 10 can simultaneously or separately connect to the control box 63, the hub or the belt 62 via the supporting pulley 114 as shown in FIGS. 7 to 9. Therefore, each one of the multifunction frames 10 can connect with the components of the electric sliding door 60 in the box 61 without using other frames. That is, the components of the electric sliding door 60 can be assembled in the box 61 via the multifunction frames 10 without increasing the whole volume of the box 61. Consequently, in assembly, the user didn't need to provide a relatively large space to assemble the electric sliding door 60 between two walls.

Furthermore, with reference to FIGS. 1 and 2, the mounting recess 111 and the side holes 113 of the body 11 can enable the belt 62 to move in the box 61, and the volume of the body 11 can enable the driving motor 64 to mount in the box 61 beside the body 11 to drive the belt 62 without using other frames. That is, the components of the electric sliding door 60 can be connected to the box 61 via the multifunction frame 10 without using other frames, and the volume of the box 61 will not be increased. Therefore, the whole volume and the whole weight of the electric sliding door 60 can be reduced and the structural complexity of the electric sliding door 60 also can be simplified. When the structural complexity of the electric sliding door 60 is simplified, the time and cost of maintaining and assembling the electric sliding door 60 can be reduced.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A multifunction frame for an electric sliding door comprising a body, a holding segment, a connecting segment, a positioning rod and a hub frame, the body having a front side, a rear side, two opposite sides, a top, a bottom, a mounting recess formed in the body, a rear opening formed through the rear side of the body and communicating with the mounting recess and two side holes respectively formed through the opposite sides of the body and communicating with the mounting recess, the holding segment formed on and protruding from the bottom of the body, the connecting segment formed on and protruding from the top of the body and having a top, at least one sliding groove formed in the top of the connecting segment and at least one connecting hook formed on and protruding from the top of the connecting segment, the positioning rod formed on and protruding from the front side of the body near the top of the body, and the hub frame formed on and protruding from the front side of the body below the positioning rod.

2. The multifunction frame for an electric sliding door as claimed in claim 1, wherein the body has at least one supporting pulley mounted in the mounting recess of the body.

3. The multifunction frame for an electric sliding door as claimed in claim 2, wherein the holding segment has two holding hooks formed on and protruding from the lower side of the body and facing to each other.

4. The multifunction frame for an electric sliding door as claimed in claim 3, wherein the hub frame has a front side and a front opening formed through the front side of the hub frame.

5. The multifunction frame for an electric sliding door as claimed in claim 4, wherein the multifunction frame has a supporting arm connected to the holding segment between the holding hooks.

6. The multifunction frame for an electric sliding door as claimed in claim 5, wherein the multifunction frame has a control box connected to the holding hooks of the holding segment.

7. The multifunction frame for an electric sliding door as claimed in claim 3, wherein the multifunction frame has a supporting arm connected to the holding segment between the holding hooks.

8. The multifunction frame for an electric sliding door as claimed in claim 3, wherein the multifunction frame has a control box connected to the holding hooks of the holding segment.

9. The multifunction frame for an electric sliding door as claimed in claim 4, wherein the multifunction frame has a control box connected to the holding hooks of the holding segment.
